(19) United States
(12) Patent Application Publication
(10) Pub. No.: US 2026/0336962 A1
(43) Pub. Date: Oct. 29, 2026

(54) STACKING DEVICE AND METHOD FOR MANUFACTURING ALL-SOLID-STATE BATTERY USING THE SAME

(71) Applicant: SAMSUNG SDI CO., LTD., Yongin-si, Gyeonggi-do (KR)

(72) Inventors: Sangwan HAN, Yongin-si, Gyeonggi-do (KR); Hoseob LEE, Yongin-si, Gyeonggi-do (KR); Byoungko JUNG, Yongin-si, Gyeonggi-do (KR); Jiyong LEE, Yongin-si, Gyeonggi-do (KR); Chanjin CHOI, Yongin-si, Gyeonggi-do (KR)

(73) Assignee: SAMSUNG SDI CO., LTD., Yongin-si, Gyeonggi-do (KR)

(21) Appl. No.: 18/880,179

(22) PCT Filed: Mar. 5, 2024
(86) PCT No.: PCT/KR2024/002762

§ 371 Date: Dec. 30, 2024

(30) Foreign Application Priority Data
Nov. 23, 2023 (KR) 10-2023-0163955

(51) Int. Cl. B65H 29/00; H01M 10/0585

(52) U.S. Cl. CPC B65H 29/003; H01M 10/0585; B65H 2701/19

(57) ABSTRACT

The present invention relates to a stacking device and a method for manufacturing an all-solid-state battery, and more particularly, a stacking device including a main portion, and a clamp unit disposed on the main portion, wherein the clamp unit includes a first clamp unit including a first fixing portion and a first vertical driving portion configured such that the first fixing portion moves vertically, and a second clamp unit including a second fixing portion and a second vertical driving portion configured such that the second fixing portion moves vertically. The first clamp unit and the second clamp unit are spaced apart in a first direction, the first fixing portion of the first clamp unit is configured to grip an upper surface of a first member, the second fixing portion of the second clamp unit is configured to grip an upper surface of a second member, and the upper surface of the first member and the upper surface of the second member are positioned at different heights.

### TECHNICAL FIELD

The present invention relates to a stacking device and a method for manufacturing an all-solid-state battery using the same.

### BACKGROUND ART

Lately, extensive efforts to develop batteries having high energy density and enhanced safety have been made in response to industrial demand. For example, lithium ion batteries have been put to practical use in automobiles, as well as information related appliances and communication devices. In the field of automobiles, safety is particularly stressed because failures are highly likely to cause harm to lives.

All-solid-state batteries replacing an electrolyte solution with a solid electrolyte are being suggested. The all-solid-state batteries use no combustible organic dispersion medium, and may thus have significantly reduced chances of causing fires or explosions even when short circuits take place.

### DISCLOSURE

### Technical Problem

The present invention provides a stacking device for an all-solid-state rechargeable battery having a novel structure.

The present invention also provides a method for manufacturing an all-solid-state battery using the stacking device described above.

### Technical Solution

According to an embodiment of the present invention, provided is a stacking device including a main portion and a clamp unit disposed on the main portion, wherein the clamp unit includes a first clamp unit including a first fixing portion and a first vertical driving portion configured such that the first fixing portion moves vertically, and a second clamp unit including a second fixing portion and a second vertical driving portion configured such that the second fixing portion moves vertically, the first clamp unit and the second clamp unit are spaced apart in a first direction, the first fixing portion of the first clamp unit is configured to grip an upper surface of a first member, the second fixing portion of the second clamp unit is configured to grip an upper surface of a second member, and the upper surface of the first member and the upper surface of the second member are positioned at different heights.

According to another embodiment of the present invention, provided is a method for manufacturing an all-solid-state battery using a stacking device including a first clamp unit and a second clamp unit, including preparing a laminate in which a first member and a second member on an outer portion of one surface of the first member are disposed, fixing the second member with the first clamp unit, disposing a third member on the first member where the second member surrounds the third member, and the third member has a greater height than the second member, and fixing the third member with the second clamp unit.

### Advantageous Effects

A stacking device according to the present invention may fix objects having different heights during a stacking process. Accordingly, an all-solid-state battery may have improved stacking precision.

### DESCRIPTION OF DRAWINGS

FIG. 1 is a cross-sectional view for describing an all-solid-state battery according to embodiments of the present invention;

FIG. 2 is a perspective view for describing an all-solid-state battery according to embodiments of the present invention;

FIG. 3 is a perspective view for describing a stacking device according to an embodiment of the present invention;

FIG. 4 is a front view for describing a stacking device according to an embodiment of the present invention;

FIG. 5 is a plan view for describing a stacking device according to an embodiment of the present invention;

FIG. 6 is a front view for describing a stacking device according to another embodiment of the present invention;

FIG. 7 is a plan view for describing a stacking device according to another embodiment of the present invention;

FIG. 8 is a perspective view for describing a stacking device according to another embodiment of the present invention;

FIG. 9 is a front view for describing a stacking device according to another embodiment of the present invention;

FIG. 10 is a plan view for describing a stacking device according to another embodiment of the present invention;

FIG. 11 is a perspective view for describing a stacking device according to another embodiment of the present invention;

FIG. 12 is a front view for describing a stacking device according to another embodiment of the present invention;

FIG. 13 is a plan view for describing a stacking device according to another embodiment of the present invention;

FIG. 14 is a perspective view for describing a stacking device according to another embodiment of the present invention;

FIG. 15 is a front view for describing a stacking device according to another embodiment of the present invention;

FIG. 16 is a cross-sectional view taken along line C-C′ of FIG. 14;

FIG. 17 is a perspective view for describing a stacking device according to another embodiment of the present invention;

FIGS. 18, 20, 22, 24, 26, and 28 are plan views for describing a method for manufacturing an all-solid-state battery;

FIGS. 19A and 19B are cross-sectional views taken along lines A-A′ and B-B′ of FIG. 18, respectively;

FIGS. 21A and 21B are cross-sectional views taken along lines A-A′ and B-B′ of FIG. 20, respectively;

FIGS. 23A and 23B are cross-sectional views taken along lines A-A′ and B-B′ of FIG. 22, respectively;

FIGS. 25A and 25B are cross-sectional views taken along lines A-A′ and B-B′ of FIG. 24, respectively;

FIGS. 27A and 27B are cross-sectional views taken along lines A-A′ and B-B′ of FIG. 26, respectively; and FIGS. 29A and 29B are cross-sectional views taken along lines A-A′ and B-B′ of FIG. 28, respectively.

### MODE FOR INVENTION

In order to sufficiently understand the configuration and effects of the present invention, preferred embodiments of the present invention will be described with reference to the accompanying drawings. It should be noted, however, that the present invention is not limited to the following embodiments, and may be implemented in various forms and variously modified. The embodiments herein are provided so that present invention will be thorough and complete and will fully convey the scope of the present invention to those skilled in the art.

Herein, it will be understood that when a component is referred to as being on another component, the component may be directly on another component, or an intervening third component may be present. In addition, in the drawings, thicknesses of components are exaggerated for effectively describing technical contents. Like reference numerals refer to like elements throughout.

The embodiments described herein will be explained with reference to the cross-sectional views, plan views, and/or perspective views as ideal example views of the present invention. Although the terms such as first, second, and third are used to describe various components in various embodiments herein, the components should not be limited to these terms. These terms are used only to distinguish one component from another component. Embodiments described and exemplified herein include complementary embodiments thereof.

Terms used herein are not for limiting the present invention but for describing the embodiments. As used herein, the singular forms include the plural forms as well, unless the context clearly indicates otherwise. The meaning of ‘comprises’ and/or ‘comprising’ used herein does not exclude the presence or addition of one or more other components besides a mentioned component.

Herein, when an element is referred to as being “connected” to another element, the element is ‘directly connected’ to the other element or is ‘connected to the other element with another element therebetween’.

Herein, being disposed on A indicates that B is disposed in direct contact with A or disposed on A with another layer therebetween and thus should not be interpreted as being limited to B being disposed in direct contact with A.

Herein, unless otherwise specified, an upper side in a vertical relationship indicates a third direction D3. For example, an upper surface of a member may indicate one surface in the third direction D3, and a lower surface may indicate one surface opposite to the one surface indicated by the upper surface.

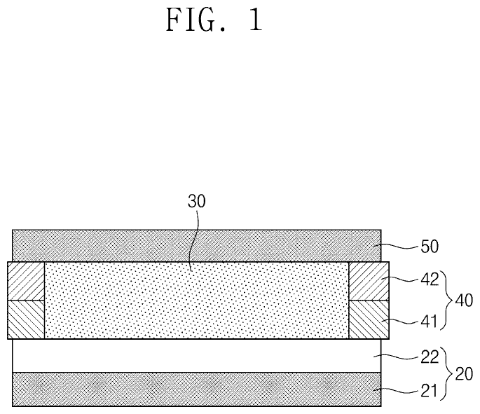

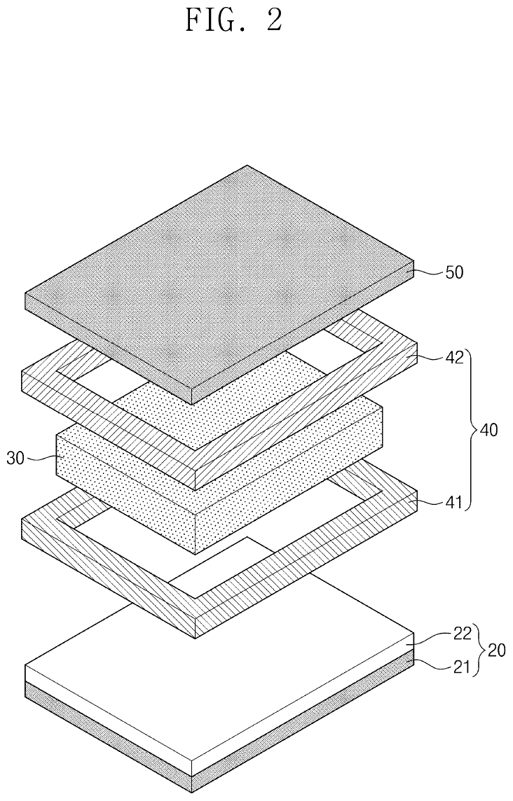

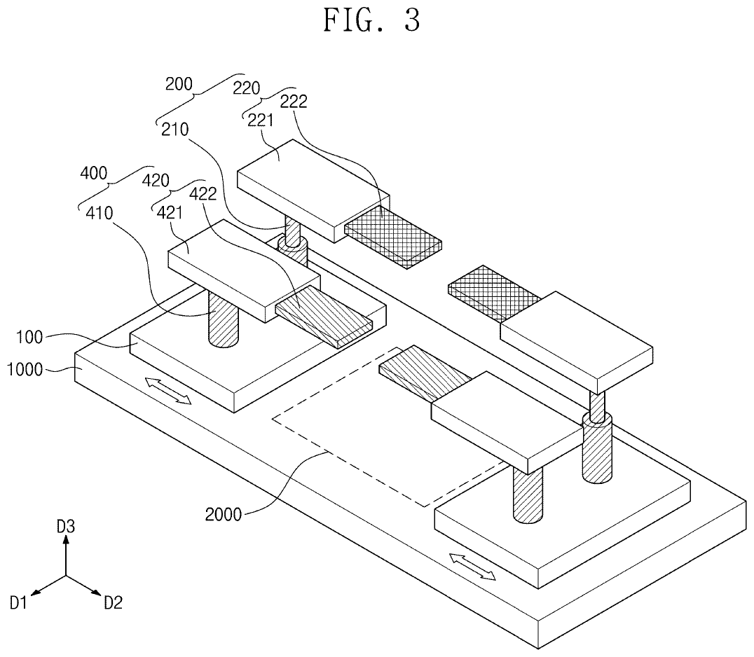

FIGS. 1 and 2 are cross-sectional views for describing an all-solid-state battery according to embodiments of the present invention. Referring to FIGS. 1 to 2, an all-solid-state battery may include a first member 20, a third member 30 disposed on the first member 20, and a multi-layer member 40 disposed on one side of the third member 30, and the multi-layer member 40 may include a second member 41 and a fourth member 42. The all-solid-state battery may further include a fifth member 50 disposed on the third member 30.

The first member 20 may include a first electrode 21 and a solid electrolyte 22. The first electrode 21 may be a positive electrode or a negative electrode. In an embodiment, the first electrode 21 may be a negative electrode. The negative electrode may include a negative electrode current collector and a negative electrode coating layer on the negative electrode current collector. The negative electrode current collector may provide a reference surface on which the negative electrode coating layer is disposed. For example, the negative electrode current collector may include a material that is not reactive with lithium, i.e., does not form either an alloy or a compound with lithium. For example, the negative electrode current collector may include at least one metal selected from the group consisting of copper (Cu), stainless steel, titanium (Ti), iron (Fe), cobalt (Co), and nickel (Ni). The negative electrode current collector may have a thickness of 1 μm to 20 μm, more specifically 5 μm to 15 μm, more specifically 7 μm to 10 μm.

The negative electrode current collector may be composed of one of the above-described metals, or may include an alloy of two or more metals or a coating material. The negative electrode current collector may be, for example, in the form of a plate or a foil. Meanwhile, in an embodiment, the negative electrode current collector may not be provided.

The negative electrode coating layer may allow lithium metal to grow between the negative electrode coating layer and the negative electrode current collector when an all-solid-state battery is charged. The negative electrode coating layer may serve as a protection layer for lithium metal and also inhibit the precipitation and growth of lithium dendrites.

The negative electrode coating layer may include metal and carbon. For example, the negative electrode coating layer may include at least one metal selected from the group consisting of gold (Au), platinum (Pt), palladium (Pd), silicon (Si), silver (Ag), aluminum (Al), bismuth (Bi), tin (Sn), and zinc (Zn). The negative electrode coating layer may include at least one carbon selected from the group consisting of carbon black, acetylene black, furnace black, ketjen black, and graphene. In an embodiment, the negative electrode coating layer may include a mixture of carbon black and silver (Ag).

The negative electrode coating layer may further include other additives in addition to metal and carbon. The negative electrode coating layer may further include at least one additive selected from the group consisting of, for example, a binder, a filler, a coating agent, a dispersant, and an ion conductive auxiliary agent.

The negative electrode coating layer may have a smaller thickness than a positive electrode active material layer. A thickness of the negative electrode coating layer is, for example, 50% or less, 40% or less, 30% or less, 20% or less, 10% or less, or 5% or less of a thickness of the positive electrode active material layer. The negative electrode coating layer may have a thickness of, for example, 1 μm to 20 μm, 2 μm to 10 μm, or 3 μm to 7 μm. When the negative electrode coating layer is too thin, the lithium dendrites formed between the negative electrode coating layer and the negative electrode current collector breakdown the negative electrode coating layer, and this may cause an all-solid-state battery to have degraded cycle characteristics. When the negative electrode coating layer is too thick, an all-solid-state battery has reduced energy density and greater internal resistance due to the negative electrode coating layer, and this may cause the all-solid-state battery to have degraded cycle characteristics. Meanwhile, although not shown, a carbon layer designed to improve adhesion between the negative electrode coating layer and the solid electrolyte 22 may be further included.

The solid electrolyte 22 may include a sulfide-based solid electrolyte disposed between a positive electrode and a negative electrode and having excellent lithium ion conductivity characteristics. The solid electrolyte layer 22 of an embodiment may include a sulfide-based solid electrolyte. The sulfide-based solid electrolyte may be prepared by subjecting starting materials (e.g., Li₂S, P₂S₅) to melt-quenching or mechanical milling. In addition, subsequently, the resulting product may be heat-treated. The solid electrolyte may be amorphous, crystalline, or a mixture thereof. In addition, the solid electrolyte may include at least sulfur(S), phosphorus (P), and lithium (Li), as component elements among the sulfide-based solid electrolyte materials described above. For example, the solid electrolyte may be a material containing Li₂S-P₂S₅. When the material containing Li₂S-P₂S₅ is used as a sulfide-based solid electrolyte material that forms the solid electrolyte, a mixing molar ratio of Li₂S and P₂S₅ (Li₂S:P₂S₅) is, for example, in a range of 50:50 to 90:10.

The sulfide-based solid electrolyte may be an argyrodite-type compound containing at least one selected from, for example, Li₇₋ₓPS₆₋ₓClₓ (0≤x≤2), Li₇₋ₓPS₆₋ₓBrₓ (0≤x≤2), and Li₇₋ₓPS₆₋ₓIₓ (0≤x≤2). In particular, the sulfide-based solid electrolyte may be an argyrodite-type compound containing at least one selected from, for example, Li₆PS₅Cl, Li₆PS₅Br, and Li₆PS₅I. The argyrodite-type solid electrolyte may have a density of 1.5 g/cc to 2.0 g/cc. The argyrodite-type solid electrolyte, when having a density of 1.5 g/cc or greater, may allow all-solid-state batteries to have reduced internal resistance and prevent solid electrolyte membranes from showing defects such as penetration and short-circuits caused by formation of lithium dendrites. The solid electrolyte has an elastic modulus of, for example, 15 GPa to 35 GPa.

The solid electrolyte 22 may further include a binder. The binder in the solid electrolyte layer 22 is, for example, styrene butadiene rubber (SBR), polytetrafluoroethylene, polyvinylidene fluoride, and polyethylene, but the embodiment of the present invention is not limited thereto. The binder of the solid electrolyte layer 22 may be the same as or different from the binder included in the positive electrode active material layer or the binder included in the negative electrode coating layer.

The third member 30 may include a second electrode. When the first electrode 21 is a positive electrode, the second electrode may be a negative electrode. When the first electrode 21 is a negative electrode, the second electrode may be a positive electrode. In an embodiment, the second electrode may be a positive electrode. The positive electrode may include a positive electrode current collector and a positive electrode active material layer disposed on the positive electrode current collector. For example, the positive electrode may have a form in which positive electrode active material layers are each applied onto both surfaces of the positive electrode current collector.

The positive electrode active material layer may include a positive electrode active material, a solid electrolyte, a conductive material, and a binder.

The positive electrode current collector may provide a reference surface on which the positive electrode active material layer is disposed. The positive electrode current collector may be in the form of a plate or a foil. For example, the positive electrode current collector may include indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof.

In an embodiment of the present invention, the positive electrode current collector may not be provided. Although not shown, a carbon layer having a thickness of 0.1 μm to 4 μm may be further disposed between the positive electrode current collector and the positive electrode active material layer to increase binding strength between the positive electrode current collector and the positive electrode active material layer.

The positive electrode active material may be a material capable of reversibly absorbing and desorbing lithium ions. For example, the positive electrode active material may include a lithium transition metal oxide such as lithium cobalt oxide (LCO), lithium nickel oxide, lithium nickel cobalt oxide, lithium nickel cobalt aluminum oxide (NCA), lithium nickel cobalt manganate (NCM), lithium manganate, or lithium iron phosphate; nickel sulfide; copper sulfide; lithium sulfide; iron oxide; or vanadium oxide, but the embodiment of the present invention is not limited thereto. The positive electrode active material may be used alone or may be a mixture of two or more types.

The lithium transition metal oxide may be, for example, a compound represented by any one among LiₐA_{1-b}B_{b}D₂ (0.90≤a≤1, 0≤b≤0.5), LiₐE_{1-b}B_{b}O_{2-c}D_{c} (0.90≤a≤1, 0≤b≤0.5, 0≤c≤0.05), LiE_{2-b}B_{b}O_{4-c}D_{c} (0≤b≤0.5, 0≤c≤0.05), LiₐNi_{1-b-c}Co_{b}B_{c}D_{α} (0.90≤a≤1, 0≤b≤0.5, 0≤c≤0.05, 0≤α2), LiₐNi_{1-b-c}Co_{b}B_{c}O_{2-α}F_{α} (0.90≤a≤1, 0≤b≤0.5, 0≤c≤0.05, 0≤α≤2), LiₐNi_{1-b-c}Mn_{b}B_{c}D_{α} (0.90≤a≤1, 0≤b≤0.5, 0≤c≤0.05, 0≤α≤2), LiₐNi_{1-b-c}Mn_{b}B_{c}O₂₋ₐF_{α} (0.90≤a≤1, 0≤b<0.5, 0≤c≤0.05, 0≤α≤2), LiₐNi_{b}E_{c}G_{d}O₂ (0.90≤a≤1, 0≤b≤0.9, 0≤c≤0.5, 0.001≤≤d≤0.1), LiₐNi_{b}Co_{c}Mn_{d}GeO₂ (0.90≤a≤1, 0≤b≤0.9, 0≤c≤0.5, 0≤d≤0.5, 0.001≤e≤0.1), LiₐNiG_{b}O₂ (0.9≤a≤1, 0.001≤b≤0.1), LiₐCoG_{b}O₂ (0.90≤a≤1, 0.001≤b≤0.1), LiₐMnG_{b}O₂ (0.90≤a≤1, 0.001≤b≤0.1), LiₐMn₂GbO₄ (0.90≤a≤1, 0.001≤b≤0.1), QO₂, QS₂, LiQS₂, V₂O₅, LiV₂O₅, LiIO₂, LiNiVO₄, Li_{3-f}J₂(PO₄)₃ (0≤f≤2), Li_{3-f}Fe₂(PO₄)₃ (0≤f≤2), and LiFePO₄. In the compound, capital “A” is nickel (Ni), cobalt (Co), manganese (Mn), or a combination thereof; capital “B” is aluminum (Al), nickel (Ni), cobalt (Co), manganese (Mn), chromium (Cr), iron (Fe), magnesium (Mg), strontium (Sr), vanadium (V), a rare earth element, or a combination thereof; capital “D” is oxygen (O), fluorine (F), sulfur(S), phosphorus (P), or a combination thereof; capital “E” is cobalt (Co), manganese (Mn), or a combination thereof; capital “F” is fluorine (F), sulfur(S), phosphorus (P), or a combination thereof, capital “G” is (Al), chromium (Cr), manganese (Mn), iron (Fe), magnesium (Mg), lanthanum (La), cerium (Ce), strontium (Sr), vanadium (V), or a combination thereof; capital “Q” is titanium (Ti), molybdenum (Mo), manganese (Mn), or a combination thereof; capital “I” is chromium (Cr), vanadium (V), iron (Fe), scandium (Sc), yttrium (Y), or a combination thereof; and capital “J” is vanadium (V), chromium (Cr), manganese (Mn), cobalt (Co), nickel (Ni), copper (Cu), or a combination thereof.

The positive electrode active material may include, for example, a lithium salt of the transition metal oxide that has a layered rock salt type structure among the examples of the lithium transition metal oxide. For example, the “layered rock salt type structure” indicates a structure in which oxygen atomic layers and metal atomic layers are alternately arranged regularly in a <111> direction of a cubic rock salt type structure, and as a result, each atomic layer forms a two-dimensional plane. The “cubic rock salt type structure” indicates a sodium chloride (NaCl) type structure, which is one type of crystal structures, and in particular, a structure in which face centered cubic (fcc) lattices formed by respective anions and cations are misaligned with respect to each other by ½ of the ridge of a unit lattice. The lithium transition metal oxide having this layered rock salt type structure may be a ternary lithium transition metal oxide, such as LiNiₓCo_{y}Al_{z}O₂ (NCA) or LiNiₓCo_{y}Mn_{z}O₂ (NCM) (0<x<1, 0<y<1, 0<z<1, x+y+z=1). When the positive electrode active material includes a ternary lithium transition metal oxide having a layered rock salt type structure, the all-solid-state battery 10 may have greater energy density and improved thermal stability.

The above-described compounds included in the positive electrode active material may be covered by a coating layer (not shown). The positive electrode active material may also be used as a mixture of the above-described compounds and a compound to which a coating layer is added. Meanwhile, the coating layer added to a surface of the positive electrode active material may include, for example, oxide, hydroxide, oxyhydroxide, oxycarbonate, or hydroxycarbonate of the following coating elements. The compounds forming the coating layer may be amorphous or crystalline. The coating elements included in the coating layer may be Mg, Al, Co, K, Na, Ca, Si, Ti, V, Sn, Ge, Ga, B, As, Zr, or a mixture thereof. The coating layer may include, for example, Li₂O-ZrO₂ (LZO). The coating layer may be formed using any method that does not adversely affect the physical properties of the positive electrode active material. For example, the coating layer may be formed using a spray coating method or a dipping method.

When the positive electrode active material includes nickel (Ni) as a ternary lithium transition metal oxide such as NCA or NCM, the capacity density of an all-solid-state battery may increase, and thus the metal elution of the positive electrode active material may be reduced in a charged state. Accordingly, the all-solid-state battery may have improved cycle characteristics in a charged state. Meanwhile, the “cycle characteristics” are characteristics that indicate the degree to which an all-solid-state battery is deteriorated due to charging/discharging of the all-solid-state battery, and in an all-solid-state battery having high cycle characteristics, the degree of degradation caused by charging/discharging may be insignificant, and in an all-solid-state battery having low cycle characteristics, the degree of degradation caused by charging/discharging may be significant.

The shape of the positive electrode active material may include, for example, particle shapes such as spheres and ellipsoids. The particle size and content of the positive electrode active material are not particularly limited.

The solid electrolyte may include a sulfide-based solid electrolyte having excellent lithium ion conductivity characteristics. The sulfide-based solid electrolyte may include, for example, at least one selected from Li₂S-P₂S₅, Li₂S-P₂S₅-LiX (where X is a halogen element), Li₂S-P₂S₅-Li₂O, Li₂S-P₂S₅-Li₂O-LiI, Li₂S-SiS₂, Li₂S-SiS₂-LiI, Li₂S-SiS₂-LiBr, Li₂S-SiS₂-LiCl, Li₂S-SiS₂-B₂S₃-LiI, Li₂S-SiS₂-P₂S₅-LiI, Li₂S-B₂S₃, Li₂S-P₂S₅-ZₘSₙ (where m and n are positive numbers, and capital “Z” is one of Ge, Zn, or Ga), Li₂S-GeS₂, Li₂S-SiS₂-Li₃PO₄, Li₂S-SiS₂-LiₚMO_{q} (where p and q are positive numbers, and “M” is one of P, Si, Ge, B, Al, Ga, or In), Li₇₋ₓPS₆₋ₓClₓ (0≤x≤2), Li₇₋ₓPS₆₋ₓBrₓ (0≤x≤2), and Li₇₋ₓPS₆₋ₓIₓ (0≤x≤2).

The sulfide-based solid electrolyte may be an argyrodite-type compound containing at least one selected from, for example, Li₇₋ₓPS₆₋ₓClₓ (0≤x≤2), Li₇₋ₓPS₆₋ₓBrₓ (0≤x≤2), and Li₇₋ₓPS₆₋ₓIₓ (0≤x≤2). In particular, the sulfide-based solid electrolyte may be an argyrodite-type compound containing at least one selected from, for example, Li₆PS₅Cl, Li₆PS₅Br, and Li₆PS₅I. The argyrodite-type solid electrolyte may have a density of 1.5 g/cc to 2.0 g/cc. The argyrodite-type solid electrolyte, when having a density of 1.5 g/cc or greater, may allow all-solid-state batteries to have reduced internal resistance and prevent solid electrolyte membranes from showing defects such as penetration and short-circuits caused by formation of lithium dendrites. The solid electrolyte may have an elastic modulus of, for example, 15 GPa to 35 GPa.

The solid electrolyte included in the positive electrode active material layer may have a smaller average (median) particle size (D50) than the solid electrolyte included in the solid electrolyte layer 22. For example, the average (median) particle size (D50) of the solid electrolyte included in the positive electrode active material layer may be 90% or less, 80% or less, 70% or less, 60% or less, 50% or less, 40% or less, 30% or less, or 20% or less of the average (median) particle size (D50) of the solid electrolyte included in the solid electrolyte layer 22. Meanwhile, the average (median) particle size (D₅₀) may be a median diameter measured using a laser particle size distribution meter.

The positive electrode active material layer may include a conductive material. The conductive material has conductivity without causing chemical changes in the all-solid-state battery 10, and may thus increase the conductivity of the positive electrode active material and the solid electrolyte. The conductive material may include a carbon-based material. The conductive material may include, for example, at least one selected from graphite, carbon black, acetylene black, carbon nanofibers, and carbon nanotubes.

The positive electrode active material layer may further include a binder. The binder may bond the positive electrode active material, the solid electrolyte, and the conductive material contained in the positive electrode active material layer, and may include a material designed to improve bonding strength with the positive electrode current collector. The binder may include, for example, polyvinylidene fluoride, styrene butadiene rubber (SBR), polytetrafluoroethylene, polyvinylidenefluoride, vinylidene fluoride/hexafluoropropylene copolymer, polyacrylonitrile, or polymethyl methacrylate.

The positive electrode active material layer may include 85 parts by weight to 92 parts by weight of the positive electrode active material with respect to 100 parts by weight of the positive electrode active material, the solid electrolyte, the conductive material, and the binder. The positive electrode active material layer may include 0.5 parts by weight to 1.5 parts by weight of the binder.

In the positive electrode active material layer, the conductive material may be present in an amount of 1 part by weight to 50 parts by weight with respect to 100 parts by weight of the solid electrolyte. When the conductive material is present in an amount of less than 1 part by weight with respect to 100 parts by weight of the solid electrolyte, the positive electrode active material layer may have reduced electrical conductivity. When the conductive material is present in an amount of greater than 50 parts by weight with respect to 100 parts by weight of the solid electrolyte, the proportion of the conductive material goes up too high, and thus a coating layer covering a surface of the solid electrolyte may not be properly formed.

According to embodiments, the positive electrode active material layer may further include at least one additive selected from the group consisting of a filler, a coating agent, a dispersant, and an ion conductive auxiliary agent, in addition to the positive electrode active material, the solid electrolyte, the conductive material, and the binder described above.

The multi-layer member 40 may be an inactive member. When the inactive member is included, the all-solid-state battery prevents cracking of the solid electrolyte 22 during manufacture and/or charging/discharging, and may thus have improved cycle characteristics. In an all-solid-state battery including no inactive member, during the manufacturing and/or charging/discharging of the all-solid-state battery, uneven pressure applied to the solid electrolyte 22 in contact with the positive electrode layer causes cracks in the solid electrolyte 22, increasing the likelihood of a short circuit.

The inactive member may include at least one selected from a lithium ion insulator or a lithium ion conductor. The inactive member may be an electronic insulator. That is, the inactive member may not be an electronic conductor. The inactive member may be an ion insulator. That is, the inactive member may not be an ion conductor. The inactive member may be an organic material, an inorganic material, or an organic-inorganic composite material. The organic material may be, for example, a polymer. The inorganic material may be, for example, ceramic such as a metal oxide. The organic-inorganic composite material may be a composite of a polymer and a metal oxide.

The inactive member may be a member containing no electrochemically active material, for example, an electrode active material. The electrode active material is a material absorbing/desorbing lithium. The inactive member is a material other than the electrode active material and formed of a material used in the art.

The multi-layer member 40 may include a multi-layer structure. For example, the multi-layer member 40 may include a second member 41 and a fourth member 42. Although not shown in the drawing, the second member 41 and the fourth member 42 may include an adhesive layer and a support layer. In this case, the all-solid-state battery prevents cracking of the solid electrolyte 22 during manufacture and/or charging/discharging, and may thus have further improved cycle characteristics. By providing both support and adhesion to the positive electrode layer and the solid electrolyte 22, the multi-layer member 40 may be more effective in preventing degradation of the all-solid-state battery than a single-layer structure.

The adhesive layer includes, for example, an organic material, and the support layer includes, for example, at least one selected from an organic material or an inorganic material. The adhesive layer may include, for example, a curable polymer. The curable polymer is a polymer that is cured by heat and/or pressure. The curable polymer is, for example, a solid at room temperature. The adhesive layer includes, for example, a heat-pressure curable film and/or a cured product thereof. The heat-pressure curable film is, for example, TSA-66 from Toray. The support layer may include, for example, at least one selected from paper, an insulating polymer, an ion conductive polymer, an insulating inorganic material, an oxide-based solid electrolyte, and a sulfide-based solid electrolyte. The insulating polymer may be, for example, an olefin-based polymer such as polypropylene (PP) or polyethylene (PE).

The multi-layer member 40 may include one or more multi-layer structures. Although only two multi-layer structures 41 and 42 are shown in FIGS. 1 and 2, this is presented as an example, and the number of the multi-layer structures may be, for example, 1 to 100, 1 to 50, 1 to 40, 1 to 30, 1 to 20, or 1 to 10. As the number of multi-layer structures included in the multi-layer member 40 increases, the multi-layer member exhibits increased film strength, thereby more effectively preventing unevenness of pressure applied to the solid electrolyte 22 during a process of pressing or charging/discharging.

A thickness of the multi-layer member 40 may be equal to or less than a thickness of the third member 30. When the thickness of the multi-layer member 40 is equal to or less than the thickness of the third member 30, the third member 30 and the solid electrolyte 22 sufficiently come in contact, thereby reducing interfacial resistance between the third member 30 and the solid electrolyte 22.

The thickness of the multi-layer member 40 may be substantially equal to the thickness of the third member 30. When the thickness of the multi-layer member 40 is substantially equal to the thickness of the third member 30, uniform pressure is applied to the solid electrolyte (22) during the process of manufacturing and/or charging/discharging the all-solid-state battery, and thus the formation of cracks in the solid electrolyte 22 is inhibited, thereby preventing short circuits in the all-solid-state battery. Herein, the fact that two thicknesses are substantially the same indicates that a difference between the two thicknesses is 10% or less, 5% or less, or 3% or less. For example, the thickness of the multi-layer member 40 may be 0.9 times, 0.95 times, 0.97 times, or 1.0 times, and may be 1.1 times, 1.05 times, or 1.03 times, the thickness of the third member 30.

The multi-layer member 40 may be, for example, a gasket. When the gasket is used as the multi-layer member 40, cracks in the solid electrolyte 22, caused by a pressure difference during the pressing process may be effectively prevented. The multi-layer member 40 is, for example, a multi-layer gasket.

The fifth member 50 may include a third electrode and a solid electrolyte, although not shown. The third electrode may be substantially the same electrode as the first electrode 21. The third electrode may be a positive electrode or a negative electrode. The third electrode may be a negative electrode. Herein, the two electrodes being substantially the same indicates that both electrodes are positive electrodes or both electrodes are negative electrodes. For example, both the third electrode and the first electrode may be positive electrodes. Both the third electrode and the first electrode may be negative electrodes.

According to an embodiment of the present invention, the first member may include a negative electrode, the third member may include a positive electrode, the fifth member may include a negative electrode, and the second member and the fourth member may include an inert member.

In this case, a width of the inert member extending from one side of the positive electrode to an end of the solid electrolyte may be 1 to 30%, 1 to 25%, 1 to 20%, 1 to 15%, 1 to 10%, or 1 to 5% of a width of the positive electrode. When the width of the inert member is too large, the all-solid-state battery has reduced energy density. When the width of the inert member is too small, the effect of disposing the inert member is insignificant.

An area of the positive electrode is smaller than an area of the solid electrolyte in contact with the positive electrode, and the inert member is disposed to surround a side of the positive electrode to compensate for a difference in area between the positive electrode and the solid electrolyte. By compensating for the difference in area between the positive electrode and the solid electrolyte, the cracking of the solid electrolyte layer caused by the pressure difference during the pressing process may be effectively inhibited. For example, the sum of the area of positive electrode and the area of the inert member is equal to the area of the solid electrolyte.

The area of the positive electrode may be, for example, less than 100%, 99% or less, 98% or less, 97% or less, 96% or less, 85% or less, or 93% or less of the area of the solid electrolyte. For example, the area of the positive electrode may be 50% to less than 100%, 50% to 99%, 55% to 98%, 60% to 97%, 70% to 96%, 80% to 95%, or 85% to 95% of the area of the solid electrolyte.

When the area of the positive electrode is equal to or greater than the area of the solid electrolyte, the possibility of a short circuit taking place due to physical contact between the positive electrode and the negative electrode coating layer or overcharging of lithium increases. The area of the positive electrode is, for example, equal to the area of the positive electrode active material layer. The area of the positive electrode is, for example, equal to the area of the positive electrode current collector.

The area of the inert member may be 50% or less, 40% or less, 30% or less, 20% or less, or 10% or less of the area of the positive electrode. For example, the area of the inert member may be 1% to 50%, 5% to 40%, 5% to 30%, 5% to 20%, or 5% to 15% of the area of the positive electrode.

The area of the positive electrode may be smaller than the area of the negative electrode current collector. For example, the area of the positive electrode may be less than %, 99% or less, 98% or less, 97% or less, 96% or less, 85% or less, or 93% or less of the negative electrode current collector. For example, the area of the positive electrode may be 50% to less than 100%, 50% to 99%, 55% to 98%, 60% to 97%, 70% to 96%, 80% to 95%, or 85% to 95% of the area of the negative electrode current collector. The area of the negative electrode current collector is, for example, the same as the area of the negative electrode layer. The area of the negative electrode current collector is, for example, the same as the area of the negative electrode coating layer.

FIG. 3 is a perspective view for describing a stacking device for an all-solid-state battery according to embodiments of the present invention.

Referring to FIG. 3, a stacking device may include a stage 1000, a main portion 100, a first clamp unit 200, and a second clamp unit 400. Members of the all-solid-state battery may be stacked in a working region 2000 of the stage 1000.

Meanwhile, although not shown, the stage 1000 may include a means for moving components to be stacked in the working region 2000 in a process flow direction. The process flow direction may be a first direction D1, but is not necessarily limited thereto.

Referring to FIG. 3, the main portion 100 may be disposed on the stage 1000.

The main portion 100 may be configured to move in a substrate direction. Referring to FIG. 3, the substrate direction may be a second direction D2 crossing the first direction D1. Specifically, the main portion 100 may be configured to move back and forth in the second direction D2. A pair of guide rails and a guide block coupled to be connected to the guide rails may be provided on a lower surface of the main portion 100 and on the stage 1000. The guide rails and the guide block are configured by applying a mechanical element commonly referred to as an LM guide, and thus a description of a specific structure will be skipped. However, the means for moving the main portion 100 back and forth in the second direction D2 is not necessarily limited to the LM guide. For example, the main portion 100 may include a driving device using electricity, hydraulics, compressed air, and the like. Meanwhile, although not shown, the main portion 100 may further include an actuator. The moving of the main portion 100 second direction D2 back and forth in the second direction D2 may involve adjusting the position of the clamp units 200 and 400 to fix members stacked in the working region 2000.

Meanwhile, although not shown, the main portion 100 may further include a means for moving in the process flow direction. The process flow direction may be a first direction D1, but is not necessarily limited thereto.

Referring to FIG. 3, the clamp units 200 and 400 may be disposed on the main portion 100. The clamp units 200 and 400 may include a first clamp unit 200 and a second clamp unit 400. The first clamp unit 200 and the second clamp unit 400 may be spaced apart in the first direction D1. The first clamp unit 200 and the second clamp unit 400 may be configured to grip different portions of the stacked members. Specifically, the first fixing portion of the first clamp unit may be configured to grip an upper surface of the first member, and the second fixing portion of the second clamp unit may be configured to grip an upper surface of the second member. The first clamp unit 200 and the second clamp unit 400 may each be configured to grip members stacked at different heights. The first clamp unit 200 and the second clamp unit 400 may each be configured to grip different members having different heights. Specifically, the upper surface of the first member and the upper surface of the second member may be positioned at different heights.

Referring to FIG. 3, the first clamp unit 200 may include a first fixing portion 220 and a first vertical driving portion 210 configured to enable the first fixing portion 220 to move vertically. The second clamp unit 400 may include a second fixing portion 420 and a second vertical driving portion 410 configured to enable the second fixing portion 420 to move vertically.

The first and second vertical driving portions 210 and 410 may be configured to move vertically in a third direction D3. The first and second vertical driving portions 210 and 410 may include a driving device that is disposed between the first and second fixing portions 220 and 420 and the main portion 100 and works in a linear motion. The driving device is configured by applying a mechanical element referred to as a cylinder, and thus a description of a specific structure will be skipped. However, the configuration in which the heights of the first and second fixing portions 220 and 420 are adjustable may be included in the first and second vertical driving portions 210 and 410.

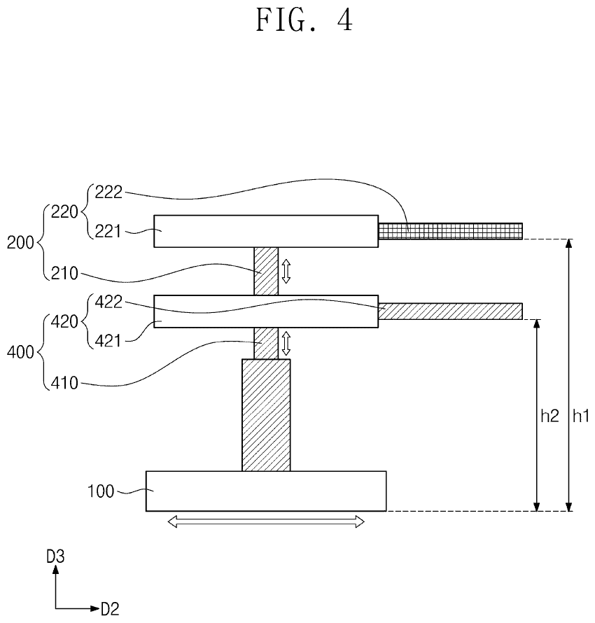

Referring to FIG. 4, the first and second vertical driving portions 210 and 410 may be independently controlled. Each of the first and second vertical driving portions 210 and 410 may be configured such that the first fixing portion 220 and the second fixing portion 420 may be positioned at the same height. Each of the first and second vertical driving portions 210 and 410 may be configured such that the first fixing portion 220 and the second fixing portion 420 may be positioned at different heights. Although FIG. 4 shows that the height of the first fixing portion 220 is greater than the height of the second fixing portion 420, the height of the second fixing portion 420 may be greater than the height of the first fixing portion 220. In this case, the first fixing portion 220 and the second fixing portion 420 may each grip members stacked at different heights. The first fixing portion 220 and the second fixing portion 420 may each grip different members having different heights. For example, the first fixing portion 220 of the first clamp unit 200 may be configured to grip an upper surface of the first member, and the second fixing portion 420 of the second clamp unit 400 may be configured to grip an upper surface of the second member.

Referring to FIG. 3, the first fixing portion 220 may include a first connecting portion 221 and a first fixing means 222. The second fixing portion 420 may include a second connecting portion 421 and a second fixing means 422.

The first connecting portion 221 may connect the first vertical driving portion 210 and the first fixing means 222. The first connecting portion 221 may be detachably coupled to the first fixing means 222. In this case, the first fixing means 222, when damaged or worn, may be repaired by replacing only the first fixing means 222 without replacing an entire stacking device, making maintenance of a stacking device easier.

The description of the technical features described above with respect to the first connecting portion 221 may also apply to the second connecting portion 421, and thus redundant descriptions will not be provided.

The first fixing means 222 and the second fixing means 422 may be configured to grip one surface of a member of the all-solid-state battery. The first fixing means 222 and the second fixing means 422 may include a configuration for fixing one surface of a member of the all-solid-state battery through mechanical compression and vacuum adsorption, but are not necessarily limited thereto.

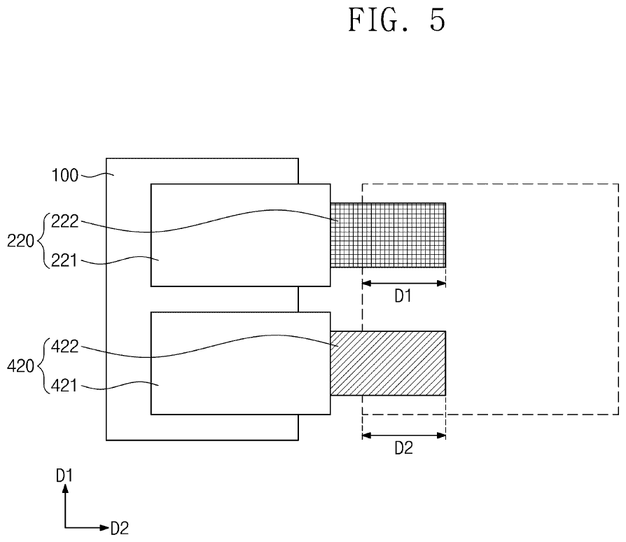

Referring to FIG. 5 as an embodiment of the present invention, the first fixing portion 220 and the second fixing portion 420 may have substantially the same length in a substrate direction. Herein, the fact that two lengths are substantially the same indicates that a difference between the two lengths is 10% or less, 5% or less, or 3% or less. For example, the length of the first fixing portion 220 in the substrate direction may be 0.9 times, 0.95 times, 0.97 times, or 1.0 times, and may be 1.1 times, 1.05 times, or 1.03 times, the length of the second fixing portion 420 in the substrate direction.

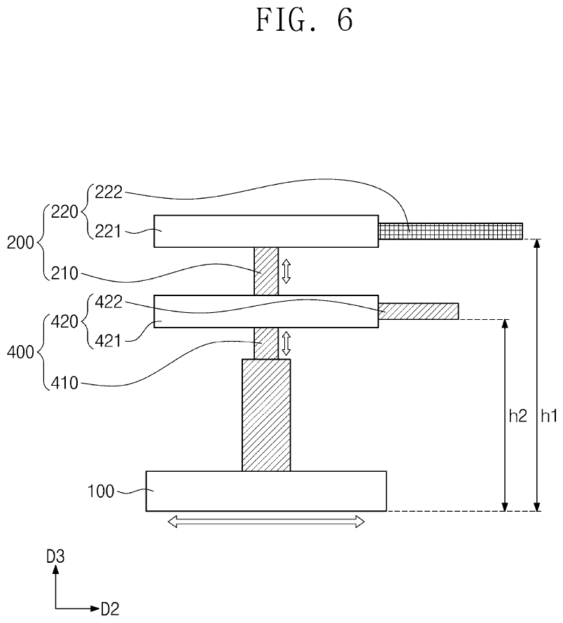

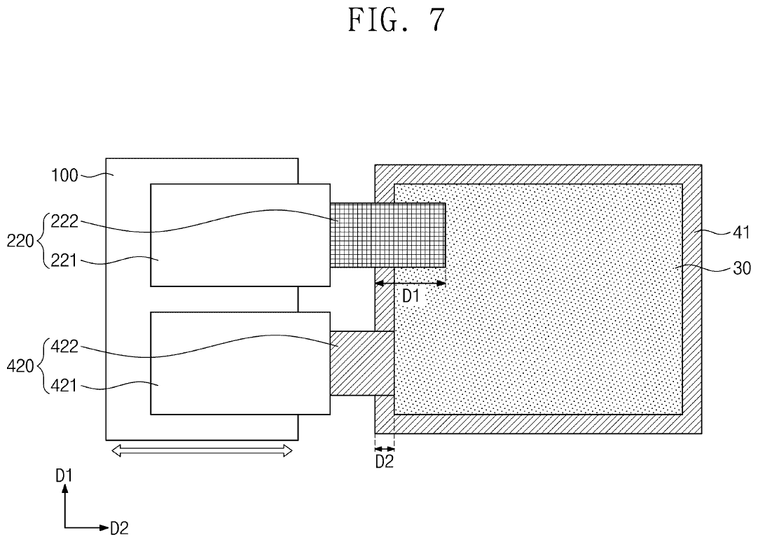

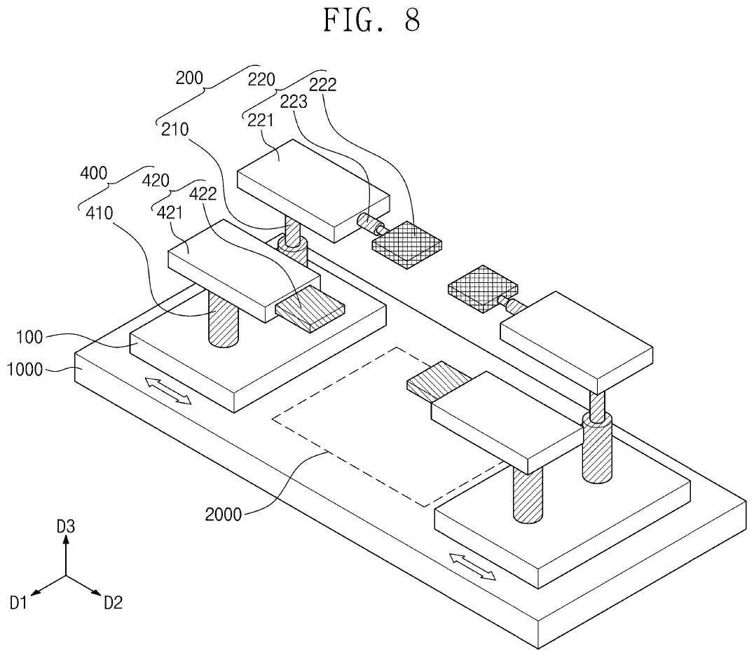

Referring to FIG. 6 as another embodiment of the present invention, the first fixing portion 220 and the second fixing portion 420 may have different lengths in the substrate direction (see FIG. 6). Referring to FIG. 7, when the first fixing portion 220 and the second fixing portion 420 have different lengths, the first fixing portion 220 and the second fixing portion 420 may each fix members having different heights.

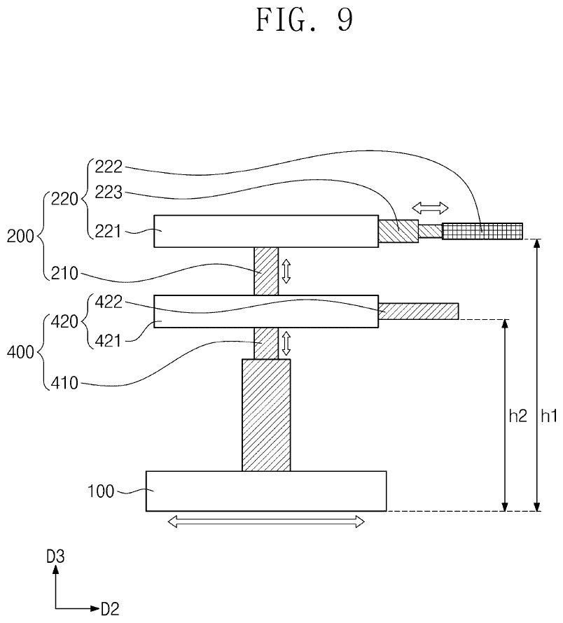

In another embodiment of the present invention, referring to FIGS. 8 to 10, the first clamp unit 200 may further include a first horizontal driving portion 223 configured to move in a substrate direction. Specifically, the first fixing portion 220 may further include a first horizontal driving portion 223.

The first horizontal driving portion 223 may be configured to move the first fixing means 222 back and forth in the second direction D2. The first horizontal driving portion 223 may include a driving device that is disposed between the first connecting portion 221 and the first fixing means 222 and works in a linear motion. The driving device is configured by applying a mechanical element referred to as a cylinder, and thus a description of a specific structure will be skipped. However, the embodiment of the present invention is not limited thereto, a configuration that a shift displacement of the first fixing means 222 in the substrate direction is adjustable may be included in the first horizontal driving portion 223.

The first horizontal driving portion 223 may be configured such that a shift displacement D1 of the first fixing portion 220 in the substrate direction is greater than a shift displacement D2 of the second fixing portion in the substrate direction. The first horizontal driving portion 223 may be disposed between the first connecting portion 221 and the first fixing means 222, and thus be configured such that a sift displacement of the first fixing means 222 in the substrate direction is greater than a shift displacement of the second fixing means 422 in the substrate direction.

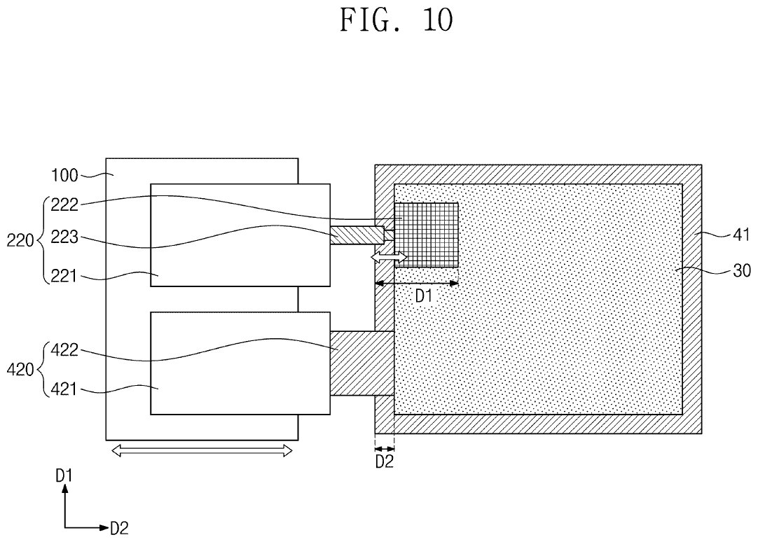

Referring to FIG. 10, the configuration is that the shift displacement D1 of the first fixing portion 220 in the substrate direction is greater than the shift displacement D2 of the second fixing portion in the substrate direction, the first fixing portion 220 and the second fixing portion 420 may each fix members having different heights.

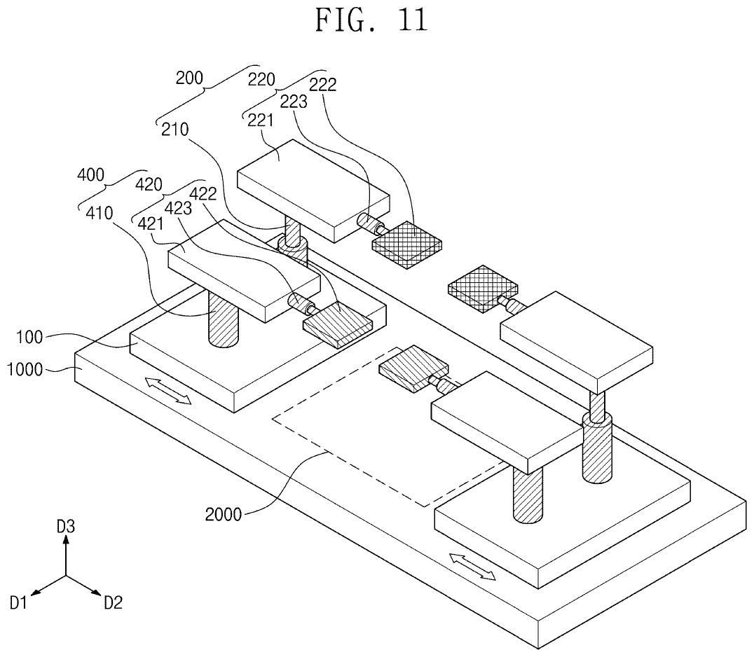

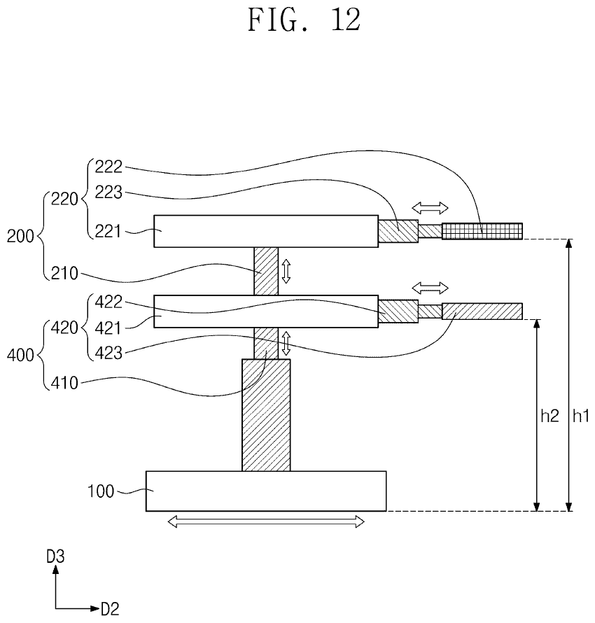

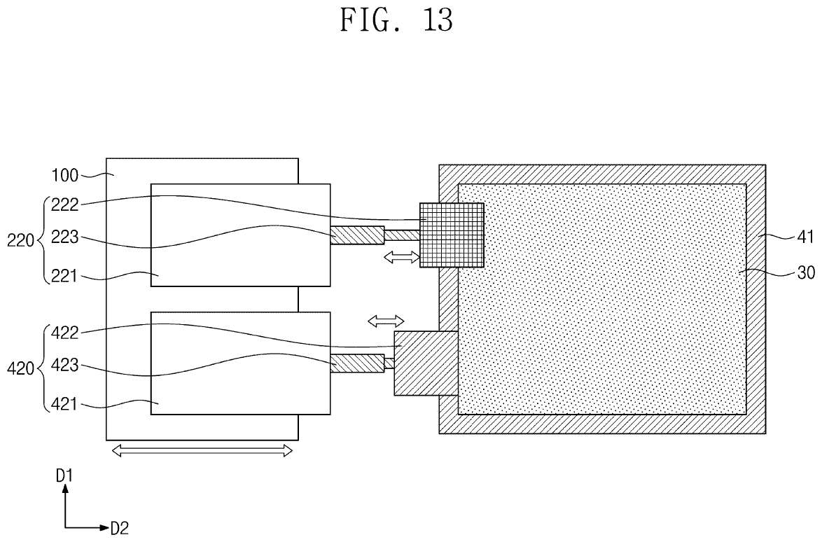

Referring to FIGS. 11 to 13 as another embodiment of the present invention, the first clamp unit 200 may further include a first horizontal driving portion 223, and the second clamp unit 400 may further include the second horizontal driving portion 423 configured to move in the substrate direction. Specifically, the first fixing portion 220 may further include the first horizontal driving portion 223, and the second fixing portion 420 may further include the second horizontal driving portion 423. The first horizontal driving portion 223 may be configured to move the first fixing means 222 back and forth in the second direction D2, and the second horizontal driving portion 423 may be configured to move the second fixing means 422 back and forth in the second direction D2. The description of the first horizontal driving portion 223 above may also apply to the second horizontal driving portion 423, and thus a detailed description thereof will be skipped.

The first and second horizontal driving portions may be configured to be independently controlled and to have different displacements in a substrate direction.

The first horizontal driving portion 223 and the second horizontal driving portion 423 may be configured such that a shift displacement D1 of the first fixing portion 220 in the substrate direction is greater than a shift displacement D2 of the second fixing portion 420 in the substrate direction. The first horizontal driving portion 223 is disposed between the first connecting portion 221 and the first fixing means 222, and the second horizontal driving portion 423 is disposed between the second connecting portion 421 and the second fixing means 422, and accordingly, the shift displacement of the first fixing means 222 in the substrate direction is greater than the displacement of the second fixing means 422 in the substrate direction.

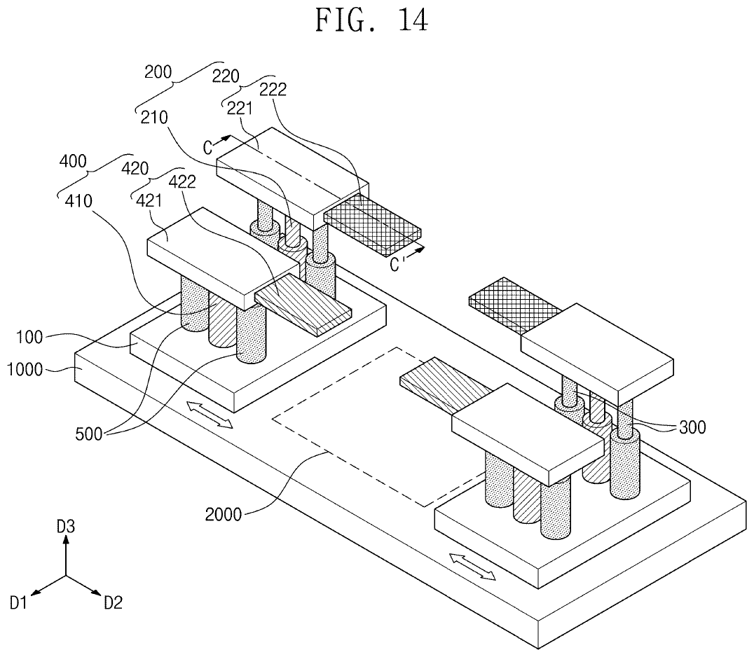

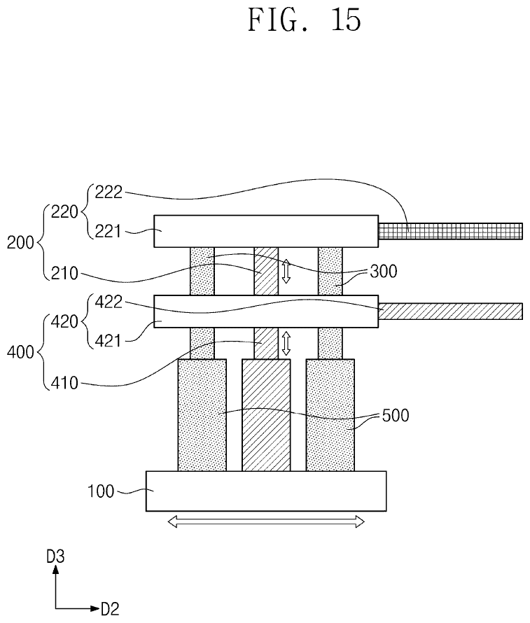

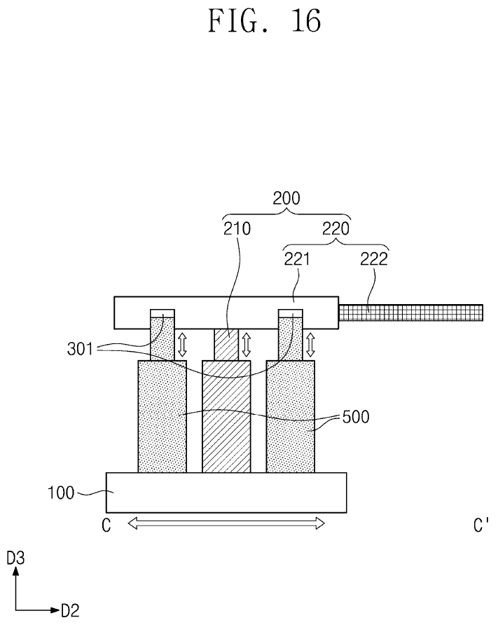

Referring to FIGS. 14 to 16 as another embodiment of the present invention, a stacking device may include a first support portion 300 and a second support portion 500 disposed on the main portion 100. The first support portion 300 may fix the first clamp unit 200 onto the main portion 100. In this case, the first support portion 300 may fix the first clamp unit 200 onto the main portion to prevent the first clamp unit 200 from shaking in the first direction D1 and the second direction D2, thereby enhancing precision when stacking members of an all-solid-state battery.

A first clearance space 301 may be defined between the first support portion 300 and the first fixing portion 220. In this case, the first support portion 300 may be configured to fix the first clamp unit 200 onto the main portion to prevent the first clamp unit 200 from shaking in the first direction D1 and the second direction D2 while enabling vertical motion in the third direction D3.

An upper part of the first support portion 300 may be coupled to the first fixing portion 220 so as to be vertically movable. That is, the first support portion 300 may be coupled so as to be vertically movable in response to changes in height of the first fixing portion 220 during substrate work. In this case, the first support portion 300 may fix the first fixing portion 220 onto the main body at different heights to prevent the first fixing portion 220 from shaking in the first direction D1 and the second direction D2.

The second support portion 500 may fix the second clamp unit 400 onto the main portion 100. In this case, the second support portion 500 may fix the second clamp unit 400 onto the main portion such to prevent the second clamp unit 400 from shaking in the first direction D1 and the second direction D2, thereby enhancing precision when stacking members of an all-solid-state battery.

A second clearance space 501 may be defined between the second support portion 500 and the second fixing portion 420. In this case, the second support portion 500 may be configured to fix the second clamp unit 400 onto the main portion to prevent the second clamp unit 400 from shaking in the first direction D1 and the second direction D2 while enabling vertical motion in the third direction D3.

An upper part of the second support portion 500 may be coupled to the second portion 420 so as to be vertically movable. That is, the second support portion 500 may be coupled so as to be vertically movable in response to changes in height of the second fixing portion 420 during substrate work. In this case, the second support portion 500 may fix the second fixing portion 420 onto the main body at different heights to prevent the second fixing portion 420 from shaking in the first direction D1 and the second direction D2.

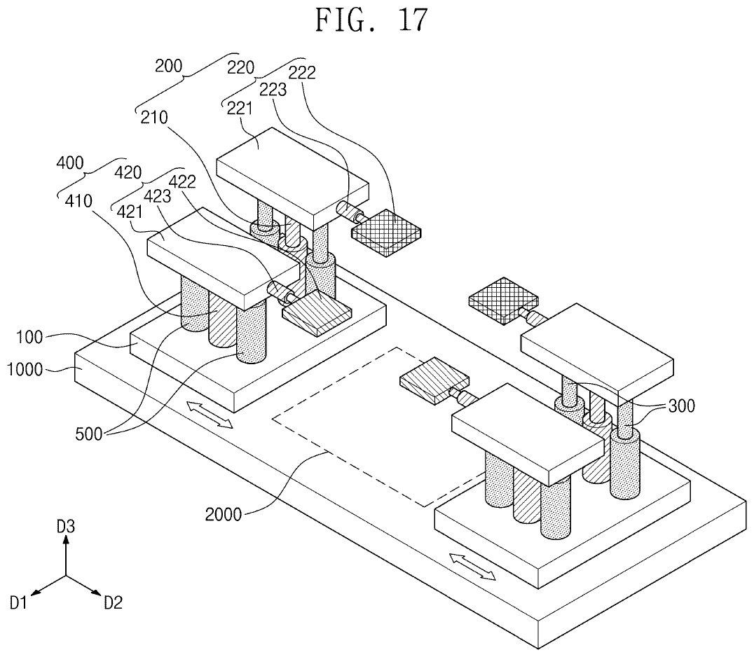

Referring to FIG. 17, a stacking device according to another embodiment of the present invention may include a stage 1000, a working region 2000, a main portion 100, a first clamp unit 200, a first support portion 300, a second clamp unit 400, and a second support portion 500, the first clamp unit 200 may include a first vertical driving portion 210 and a first fixing portion 220, the first fixing portion 220 may include a first connecting portion 221, a first horizontal driving portion 223, and a first fixing means 222, the second clamp unit 400 may include a second vertical driving portion 410 and a second fixing portion 420, and the second fixing portion 420 may include a second connecting portion 421, a second horizontal driving portion 423, and a second fixing means 422. A detailed description of the disposition and function of each component of a stacking device is skipped as the above description is applicable.

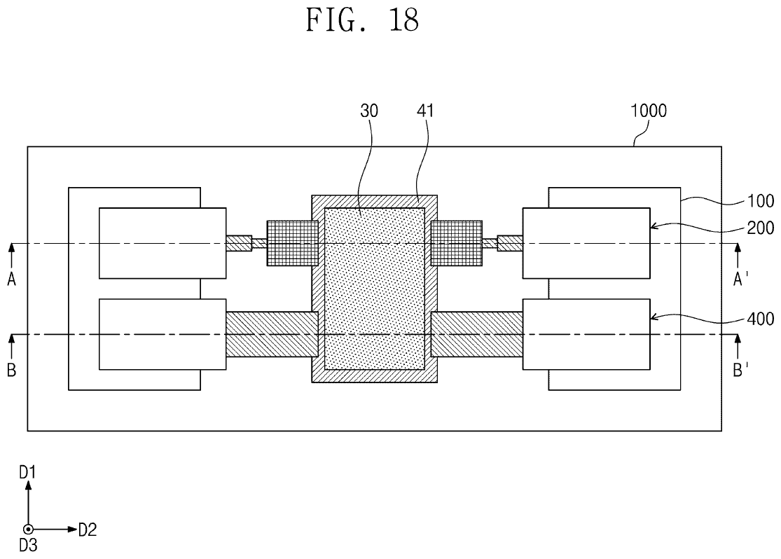

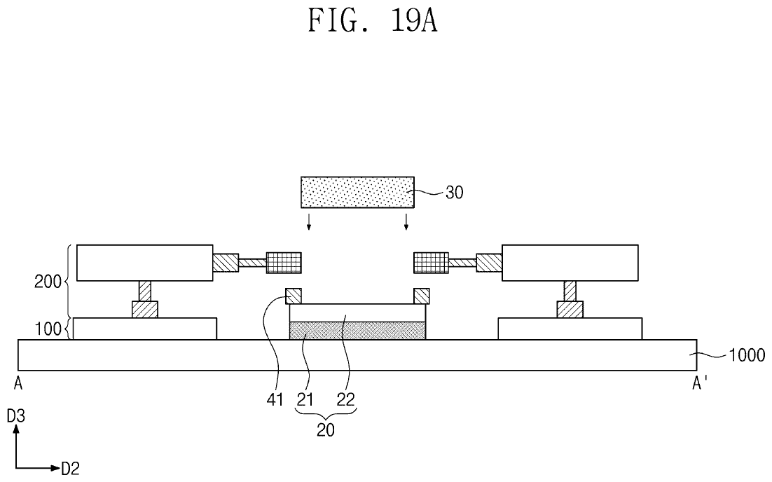

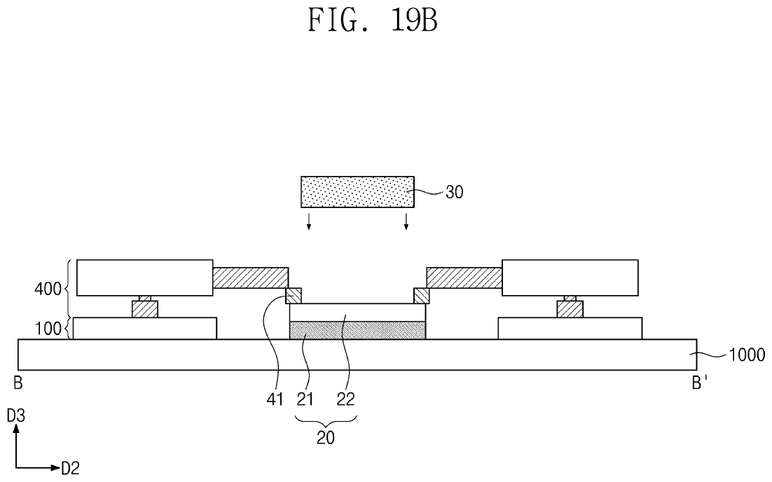

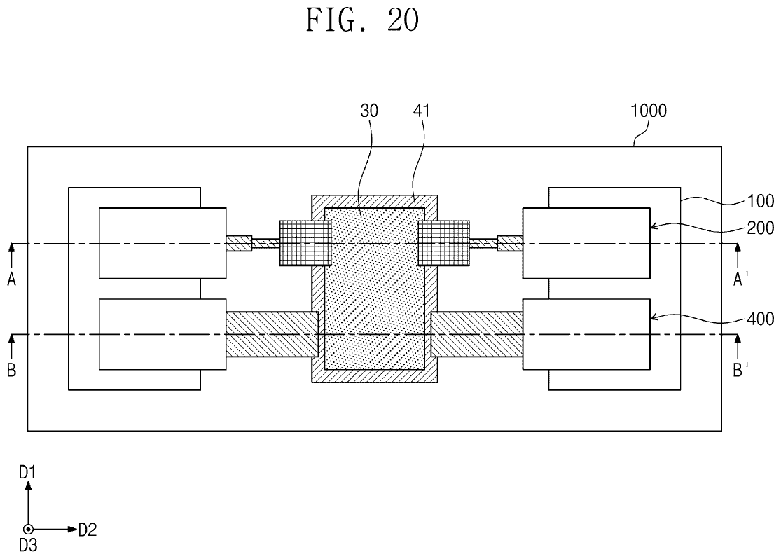

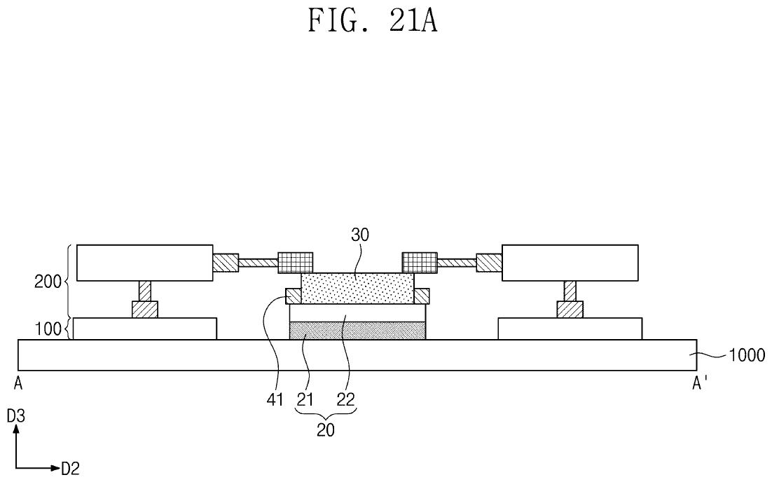

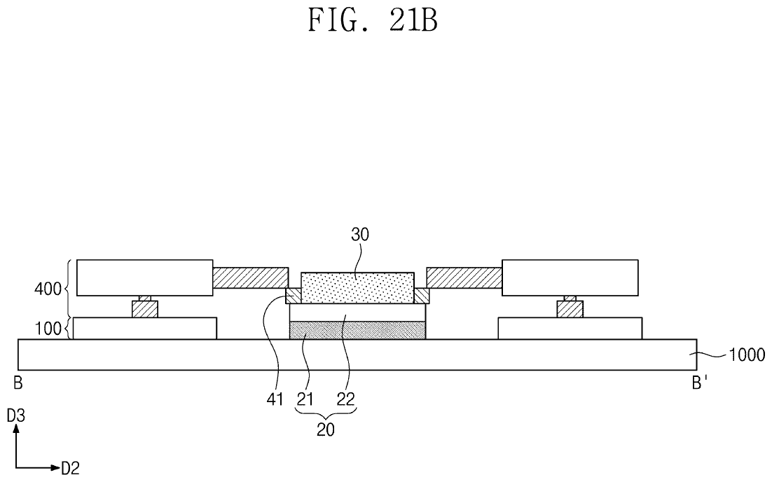

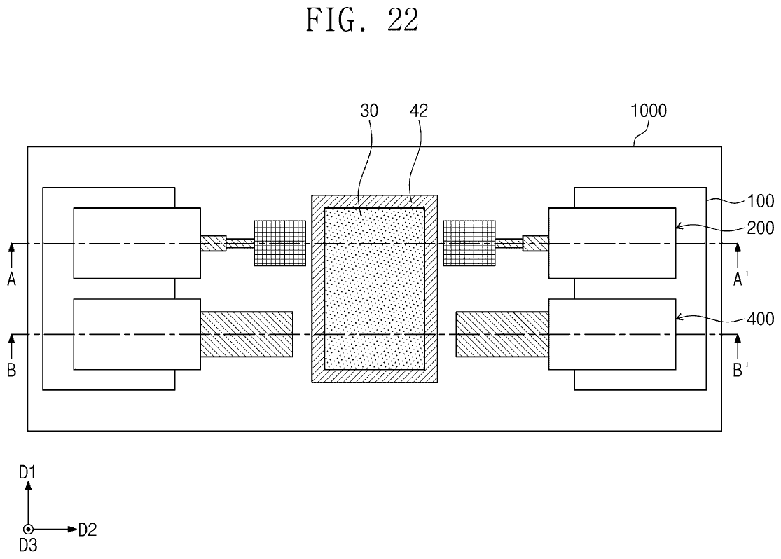

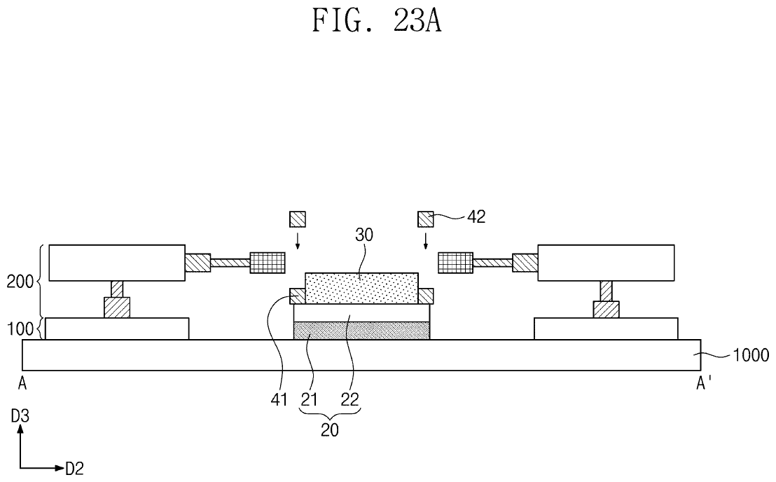

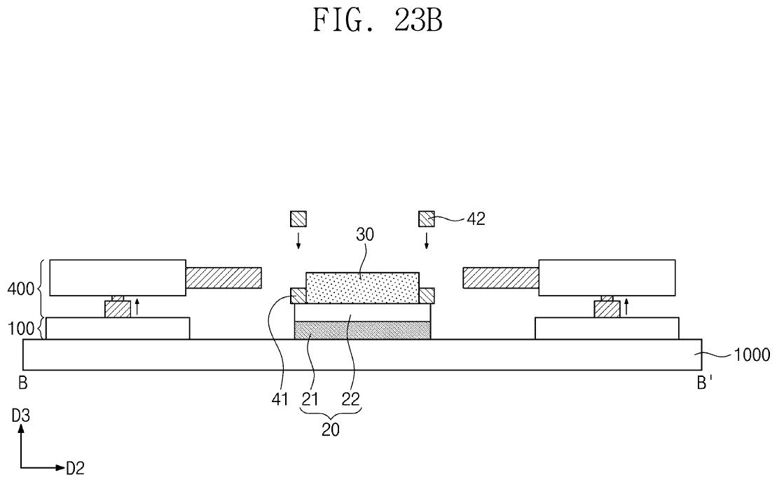

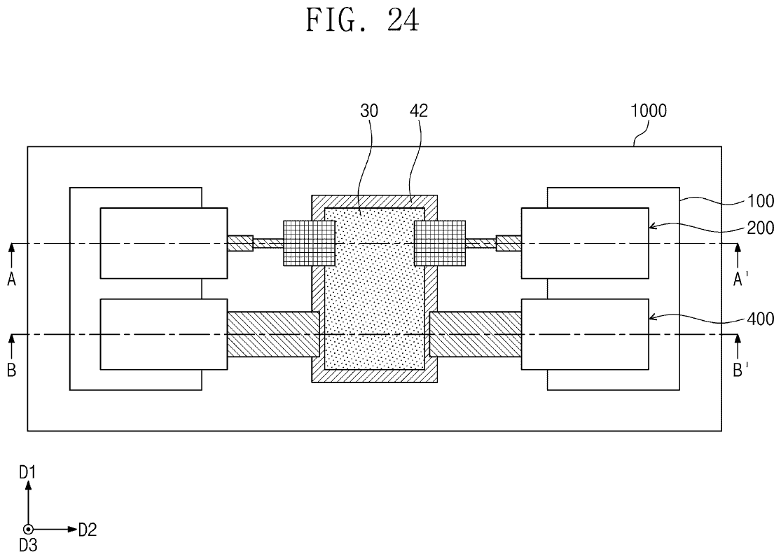

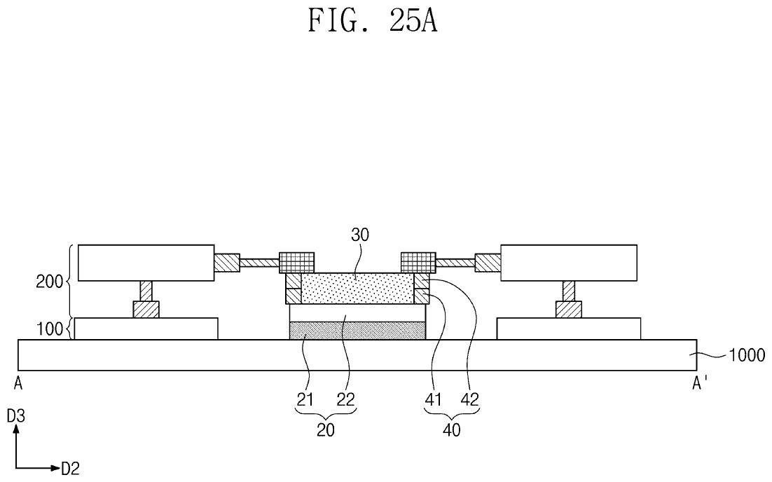

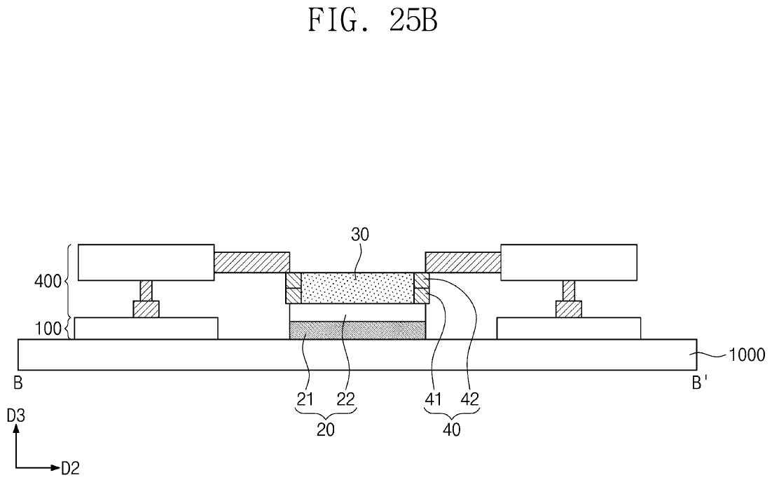

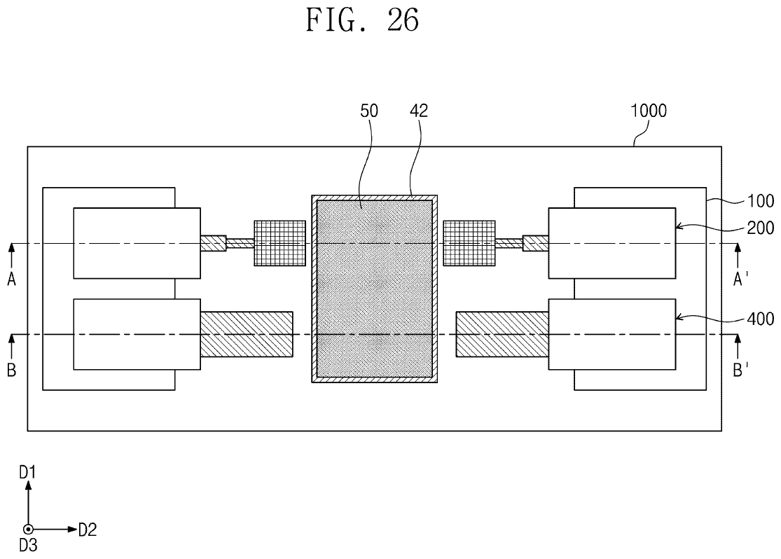

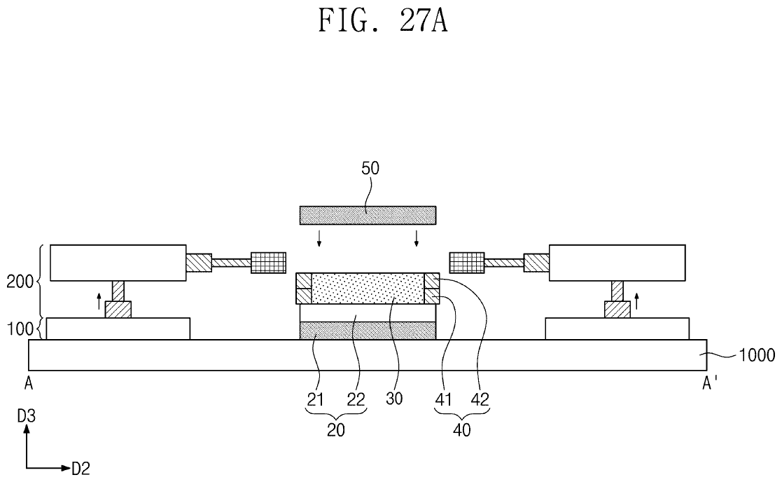

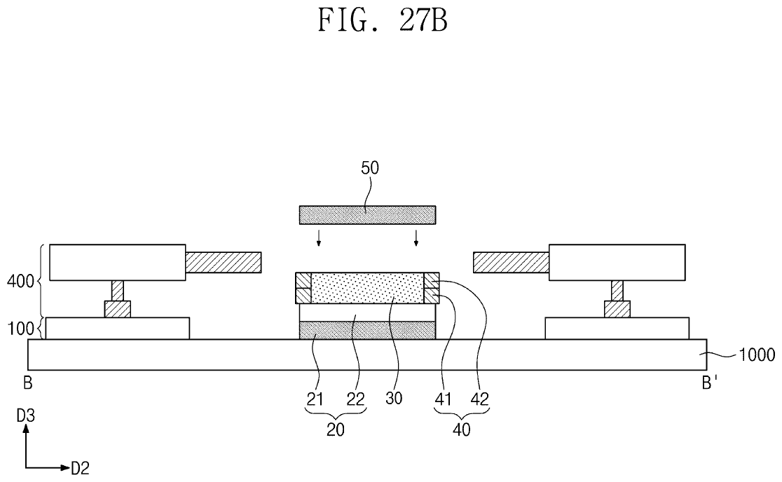

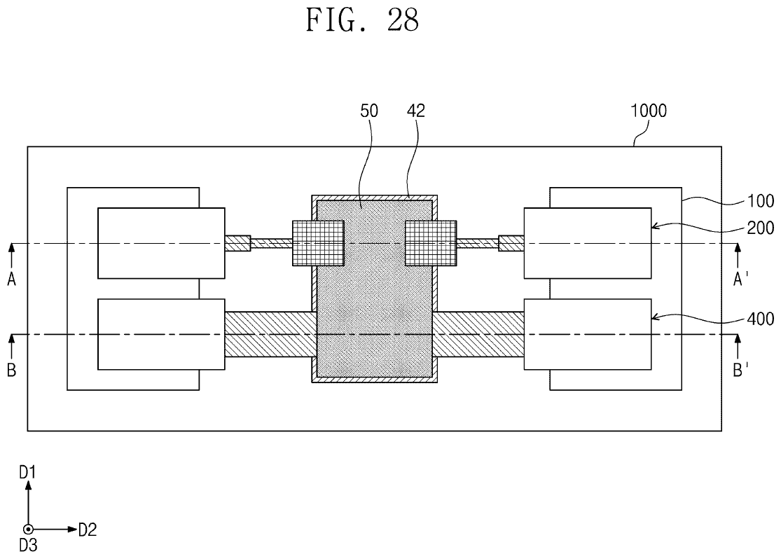

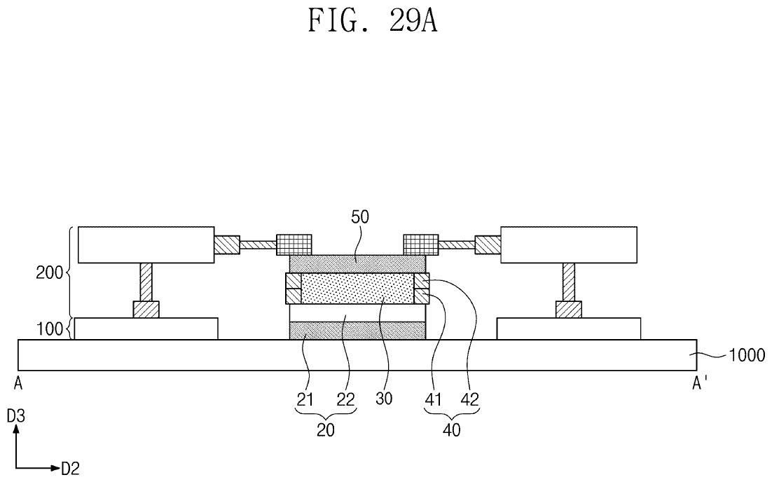

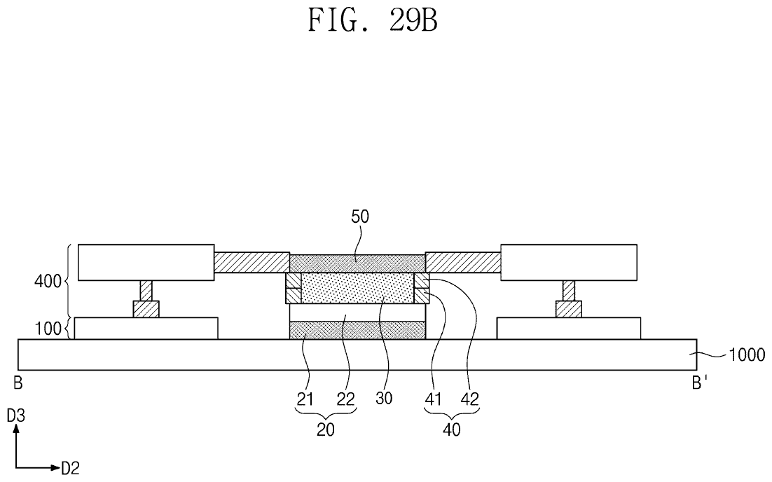

FIGS. 18, 20, 22, 24, 26, and 28 are plan views for describing a method for manufacturing an all-solid-state battery. FIGS. 19A and 19B are cross-sectional views taken along lines A-A′ and B-B′ of FIG. 18, respectively. FIGS. 21A and 21B are cross-sectional views taken along lines A-A′ and B-B′ of FIG. 20, respectively. FIGS. 23A and 23B are cross-sectional views taken along lines A-A′ and B-B′ of FIG. 22, respectively. FIGS. 25A and 25B are cross-sectional views taken along lines A-A′ and B-B′ of FIG. 24, respectively. FIGS. 27A and 27B are cross-sectional views taken along lines A-A′ and B-B′ of FIG. 26, respectively. FIGS. 29A and 29B are cross-sectional views taken along lines A-A′ and B-B′ of FIG. 28, respectively.

Referring to FIGS. 18, 19A, and 19B, a method for manufacturing an all-solid-state battery according to embodiments of the present invention may involve utilizing a stacking device including a first clamp unit 200 and a second clamp unit 400. A laminate in which a first member 20 and a second member 41 are stacked may be provided on a stage 1000. The second member 41 may be disposed on an outer portion of one surface of the first member 20. The second clamp unit 400 may grip the second member 41.

A third member 30 may be provided on the laminate of the first member 20 and the second member 41. The second clamp unit 400 gripping the second member 41 may non-overlap the third member 30 in the third direction D3. The first clamp unit 200 may non-overlap the third member 30 in the third direction D3. The third member 30 may be provided on the first member 20 without being obstructed by the first clamp unit 200 and the second clamp unit 400.

Referring to FIGS. 20, 21A, and 21B, in the method for manufacturing an all-solid-state battery according to embodiments of the present invention, a laminate in which the first member 20, the second member 41, and the third member 30 are stacked may be provided on the stage 1000. The second member 41 may surround the third member 30, and a height of the third member 30 may be greater than a height of the second member 41. The first clamp unit 200 may grip the third member 30. The second clamp unit 400 may grip the second member 41.

Referring to FIGS. 22, 23A, and 23B, in the method for manufacturing an all-solid-state battery according to embodiments of the present invention, a laminate in which the first member 20, the second member 41, and the third member 30 are stacked may be provided on the stage 1000. The stacking device may unfix the second member 41 and the third member 30. A fourth member 42 may be provided on the laminate. The first clamp unit 200 may non-overlap the fourth member 42 in the third direction D3. The second clamp unit 400 may non-overlap the fourth member 42 in the third direction D3. The fourth member 42 may be provided on the second member 41 without being obstructed by the first clamp unit 200 and the second clamp unit 400. The fourth member 42 may surround the third member 30. A height of the fourth member 42 may be substantially the same as a height of the third member 30. Herein, the fact that two heights are substantially the same indicates that a difference between the two heights is 10% or less, 5% or less, or 3% or less. For example, the height of the fourth member 42 may be 0.9 times, 0.95 times, 0.97 times, or 1.0 times, and may be 1.1 times, 1.05 times, or 1.03 times, the height of the third member 30.

Referring to FIGS. 24, 25A, and 25B, in the method for manufacturing an all-solid-state battery according to embodiments of the present invention, a laminate in which the first member 20, the multi-layer member 40, and the third member 30 are stacked may be provided on the stage 1000. The first clamp unit 200 may grip the third member 30. The second clamp unit 400 may grip the fourth member 42.

Referring to FIGS. 26, 27A, and 27B, in the method for manufacturing an all-solid-state battery according to embodiments of the present invention, a laminate in which the first member 20, the multi-layer member 40, and the third member 30 are stacked may be provided on the stage 1000. The multi-layer member 40 may surround the third member 30. The multi-layer member 40 may be disposed on an outer portion of one surface of the first member 20.

A fifth member 50 may be provided on the laminate. When viewed on a plane, an area of the fifth member 50 may be substantially equal to or greater than an area of the third member 30. When viewed on a plane, an area of the fifth member 50 may be substantially the same as or different from an area of the first member 20. Herein, the fact that two areas are substantially the same indicates that a difference between the two areas is 10% or less, 5% or less, or 3% or less. For example, the area of the first member 20 may be 0.9 times, 0.95 times, 0.97 times, or 1.0 times, and may be 1.1 times, 1.05 times, or 1.03 times, the area of the fifth member 50.

The first clamp unit 200 may non-overlap the fifth member 50 in the third direction D3. The second clamp unit 400 may non-overlap the fifth member 50 in the third direction D3. The fifth member 50 may be provided on the laminate without being obstructed by the first clamp unit 200 and the second clamp unit 400.

Referring to FIGS. 28, 29A, and 29B, in the method for manufacturing an all-solid-state battery according to embodiments of the present invention, a laminate in which the first member 20, the multi-layer member 40, the third member 30, and the fifth member 50 are stacked may be provided on the stage 1000. The first clamp device 200 may grip the fifth member 50. The second clamp device 400 may grip the fourth member 42. Accordingly, the stacking devices may each grip members having different heights of the laminate.

In the method for manufacturing an all-solid-state battery according to embodiments of the present invention, the first member 20 may include a positive electrode 21 and a solid electrolyte 22. The second member 41 may include an inactive member. The third member 30 may include a negative electrode. The fourth member 42 may include an inactive member. The fifth member 50 may include a positive electrode. The description of the positive electrode, solid electrolyte, inactive member, and negative electrode is skipped as the above description is applicable.

Although the embodiments of the present invention have been described above with reference to the accompanying drawings, the present invention may be applied in other specific forms without changing the technical idea or essential features thereof. Therefore, the above-described embodiments are to be considered in all aspects as illustrative and not restrictive.

1. A stacking device comprising:
a main portion; and
a clamp unit disposed on the main portion,
wherein the clamp unit comprises:
a first clamp unit comprising a first fixing portion and a first vertical driving portion configured such that the first fixing portion moves vertically; and
a second clamp unit comprising a second fixing portion and a second vertical driving portion configured such that the second fixing portion moves vertically,
the first clamp unit and the second clamp unit are spaced apart in a first direction,
the first fixing portion of the first clamp unit is configured to grip an upper surface of a first member,
the second fixing portion of the second clamp unit is configured to grip an upper surface of a second member, and
the upper surface of the first member and the upper surface of the second member are positioned at different heights.

2. The stacking device of claim 1, wherein the first and second vertical driving portions are independently controlled, and
the first and second vertical driving portions are each configured to enable the first fixing portion and the second fixing portion to be positioned at different heights.

3. The stacking device of claim 1, wherein the main portion is configured to move in a substrate direction, and
the substrate direction is a second direction crossing the first direction.

4. The stacking device of claim 3, wherein the first fixing portion and the second fixing portion are different in length in the substrate direction.

5. The stacking device of claim 1, wherein the first clamp unit further comprises a first horizontal driving portion,
the first horizontal driving portion is configured such that a shift displacement of the first fixing portion in the substrate direction is greater than a shift displacement of the second fixing portion in the substrate direction, and
the substrate direction is a second direction crossing the first direction.

6. The stacking device of claim 1, wherein the first clamp unit comprises a first horizontal driving portion configured to move in a substrate direction,
the second clamp unit comprises a second horizontal driving portion configured to move in the substrate direction, and
the substrate direction is a second direction crossing the first direction.

7. The stacking device of claim 1, further comprising a first support portion and a second support portion disposed on the main portion,
wherein the first support portion fixes the first clamp unit onto the main portion, and the second support portion fixes the second clamp unit onto the main portion.

8. The stacking device of claim 7, wherein a first clearance space is defined between the first support portion and the first fixing portion, and
a second clearance space is defined between the second support portion and the second fixing portion.

9. The stacking device of claim 8, wherein an upper portion of the first support portion is coupled to the first fixing portion so as to be vertically movable, and
an upper portion of the second support part is coupled to the second fixing portion so as to be vertically movable.

10. A method for manufacturing an all-solid-state battery using a stacking device comprising a first clamp unit and a second clamp unit, the method comprising:
preparing a laminate in which a first member and a second member on an outer portion of one surface of the first member are disposed;
fixing the second member with the second clamp unit;
disposing a third member on the first member, the second member surrounding the third member, and the third member having a greater height than the second member; and
fixing the third member with the first clamp unit.

11. The method of claim 10, comprising:
unfixing the second member and the third member;
disposing a fourth member on the second member, the fourth member surrounding the third member;
fixing the fourth member with the first clamp unit and fixing the third member with the second clamp unit;
unfixing the third member and the fourth member;
disposing a fifth member on the third member and the fourth member; and
fixing the fourth member with the first clamp unit and fixing the fifth member with the second clamp unit.

12. The method of claim 10, wherein the first member comprises a positive electrode and a solid electrolyte, and
the third member comprises a negative electrode.

13. The method of claim 11, wherein the first member comprises a positive electrode and a solid electrolyte,
the third member comprises a negative electrode, and
the fifth member comprises a positive electrode.

14. The method of claim 10, wherein the second member comprises an inactive member.

15. The method of claim 11, wherein the fourth member is substantially the same as the third member in height.
